(19) United States
(12) Patent Application Publication
(10) Pub. No.: US 2025/0296017 A1
(43) Pub. Date: Sep. 25, 2025

(54) SEPARATOR FOR SEPARATING SOLIDS FROM A FLUID

(71) Applicant: Hydro International Ltd, Clevedon (GB)

(72) Inventors: Jeremy Fink, Portland, ME (US); Sebastian Roesner, Readfield, ME (US)

(73) Assignee: Hydro International Ltd, Clevedon (GB)

(21) Appl. No.: 19/082,995

(22) Filed: Mar. 18, 2025

Related U.S. Application Data
(60) Provisional application No. 63/567,031, filed on Mar. 19, 2024.

(30) Foreign Application Priority Data
Apr. 30, 2024 (GB) 2406072.5

(51) Int. Cl. B01D 21/00; B01D 21/02

(52) U.S. Cl. CPC B01D 21/0045; B01D 21/0069; B01D 21/02

(57) ABSTRACT

A separator for separating solids from a fluid, wherein the separator comprises a vessel having an inlet and an outlet, and a lamella clarifier and manifold disposed in an interior of the vessel. The interior of the vessel receives the fluid via the vessel inlet. The manifold has an interior and comprises a manifold inlet, a manifold outlet and a bypass inlet. The manifold inlet is connected to the lamella clarifier so the interior of the manifold receives a first portion of the fluid from the lamella clarifier via the manifold inlet. The bypass inlet is in the interior of the vessel so the manifold receives a second portion of the fluid from the interior of the vessel via the bypass inlet and not via the lamella clarifier. The manifold outlet is connected to the outlet of the vessel such that it discharges the first and second portions of fluid.

### CROSS REFERENCE TO RELATED APPLICATIONS

This application is a non-provisional application under 35 USC § 119 (e) of, and claims priority to U.S. Provisional Patent Application Ser. No. 63/567,031, filed on Mar. 19, 2024, and claims priority to GB 2406072.5, filed on Apr. 30, 2024. The entire contents of the aforementioned disclosures are incorporated herein by reference.

### TECHNICAL FIELD

The disclosure relates to a separator for separating solids from a fluid.

### BACKGROUND

Separators comprising lamella clarifiers are known. Lamella clarifiers comprise a series of inclined plates that are disposed in a tank. Fluid containing solids is fed into the tank via an inlet, passes through gaps formed between the plates and exits the tank via an outlet. As the fluid passes through the gaps formed between the plates, some of the solids that are suspended in the fluid settle on the plates, slide down the plates and collect at the bottom of the tank, resulting in a reduction in the quantity of solids suspended in the fluid that exit the tank. However, some of the solids suspended in the fluid fail to ever settle on the plates or are resuspended after initially settling.

It is therefore desirable to provide a separator for separating solids from a fluid that overcomes this issue.

### SUMMARY

According to an aspect there is described a separator for separating solids from a fluid. The separator comprises a vessel, a lamella clarifier and manifold. The vessel comprises an inlet and an outlet. The lamella clarifier and the manifold are disposed in an interior of the vessel. The interior of the vessel is configured to receive the fluid via the inlet of the vessel. The manifold has an interior and comprises a manifold inlet, a manifold outlet and a bypass inlet.

The manifold inlet is fluidically connected to the lamella clarifier such that the interior of the manifold is configured to receive a first portion of the fluid from the lamella clarifier via the manifold inlet. The bypass inlet is disposed within the interior of the vessel such that the interior of the manifold is configured to receive a second portion of the fluid from the interior of the vessel via the bypass inlet and not via the lamella clarifier. The manifold outlet is fluidically connected to the outlet of the vessel such that it is configured to discharge the first and second portions of fluid received in the interior of the manifold to an exterior of the vessel.

The interior of the manifold may comprise a first interior portion that is configured to receive the first portion of the fluid from the lamella clarifier via the manifold inlet and a second interior portion from which the manifold outlet is configured to discharge the first and second portions of fluid to the exterior of the vessel. The manifold may further comprise a weir partially separating the first interior portion and the second interior portion.

The weir may be arched.

The separator may further comprise a siphon having an inlet disposed in the first interior portion and an outlet disposed in the second interior portion. The level of the inlet to the siphon and the level of the outlet to the siphon may be between the level of a lip of the weir and the level of the manifold inlet such that the siphon is configured to at least partially drain down fluid from the first interior portion to the second interior portion.

The weir may comprise a notch configured to receive a crest portion of the siphon.

The weir may comprise a drainage opening extending between the first interior portion and the second interior portion.

At least a portion of the manifold that extends between the manifold inlet and the bypass inlet and that defines the first interior portion may be substantially cylindrical.

At least a portion of the manifold that extends between the first interior portion and the manifold outlet and that defines the second interior portion may diverge away from the first interior portion to the manifold outlet.

At least a portion of the manifold that extends between a base of the weir and the manifold outlet may be concave.

The manifold may comprise one or more further bypass inlets. The one or more further bypass inlets may be disposed within the interior of the vessel such that the interior of the manifold is configured to receive a third portion of the fluid from the interior of the vessel via the one or more further bypass inlets and not via the lamella clarifier and not via the bypass inlet. Each of the one or more further bypass inlets may comprise a lip over which the third portion of fluid is configured to flow. The level of each of the lips of the one or more further bypass inlets may be between the level of a lip of the weir and the level of the bypass inlet.

The one or more further bypass inlets may be defined by at least one of the portions of the manifold that diverge away from the first interior portion to the manifold outlet.

The manifold may comprise a substantially planar support member that defines the bypass inlet. A portion of the manifold that defines the first interior portion and a portion of the manifold that defines the second interior portion may extend from the support member.

The lamella clarifier may comprise a plurality of frustoconical settling plates spaced apart along a separator axis. The separator may further comprise a plurality of support rods extending through each of the plurality of settling plates and connecting to the support member of the manifold.

The bypass inlet and the manifold outlet may be contiguous.

There may be provided a manifold as stated in any preceding statement.

### BRIEF DESCRIPTION OF THE DRAWINGS

For a better understanding of the present disclosure, and to show more clearly how it may be carried into effect, reference will now be made, by way of example, to the accompanying drawings, in which:

FIG. 1 is a perspective cross-sectional view of a separator for separating solids from a fluid;

FIG. 2 is a perspective view of the lamella clarifier and manifold of the separator in isolation;

FIG. 3 is a perspective view of a plate of the lamella clarifier in isolation;

FIG. 4 is a perspective view of the manifold in isolation;

FIG. 5 is a top view of the manifold in isolation;

FIG. 6 is a cross-sectional side view of the manifold in isolation;

FIG. 7 is a perspective view of the lamella clarifier and manifold showing an underside of the manifold;

FIG. 8 is a first further perspective view of the separator;

FIG. 9 is a second further perspective view of the separator;

FIG. 10 is a cross-sectional side view of the separator;

FIG. 11 is a close-up cross-sectional perspective view of interfaces between the plates and the manifold;

FIG. 12 is a close-up cross-sectional view of the separator at a region of the manifold and outlet opening;

FIG. 13 is a perspective view of a first alternative manifold; and

FIG. 14 is a perspective view of a second alternative manifold.

### DETAILED DESCRIPTION OF PREFERRED EMBODIMENTS

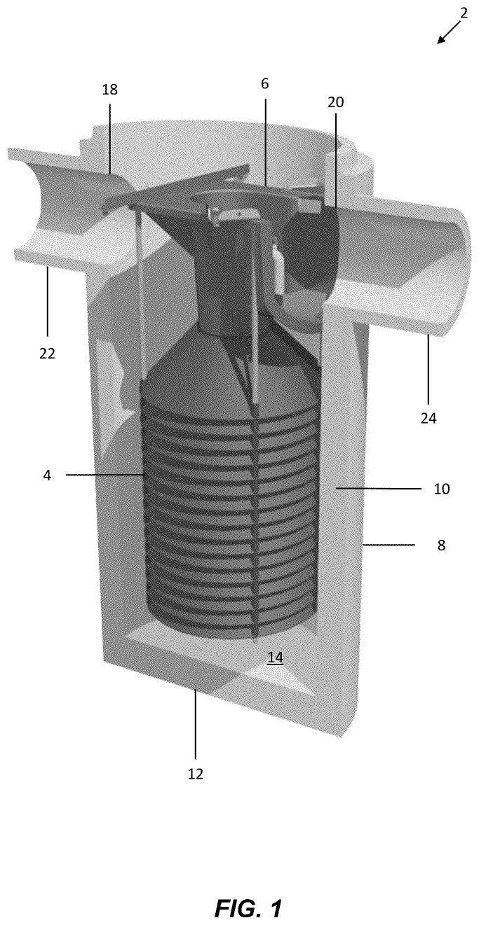

FIG. 1 is a perspective cross-sectional view of a separator 2 for separating solids from a fluid. The separator 2 generally comprises a lamella clarifier 4, a manifold 6 and a vessel 8 (also referred to as a clarifier tank). The vessel 8 comprises a side wall 10 and a base 12 that define an interior 14 of the vessel 8. The vessel 8 is shown as being cylindrical in shape, however it will be appreciated that the vessel 8 may have any shape, for example a cuboid (i.e. rectangular) shape. The lamella clarifier 4 and manifold 6 are disposed in the interior 14 of the vessel 8 configured to receive a fluid. The vessel 8 comprises an inlet 18 and an outlet 20 defined by the side wall 10. The inlet 18 and outlet 20 are connected to an inlet conduit 22 and an outlet conduit 24, respectively. It will however be appreciated that the inlet 18 and outlet 20 may be formed by other parts of the vessel 8. For example, the inlet of the vessel 8 may be defined by the upper opening of the vessel 8.

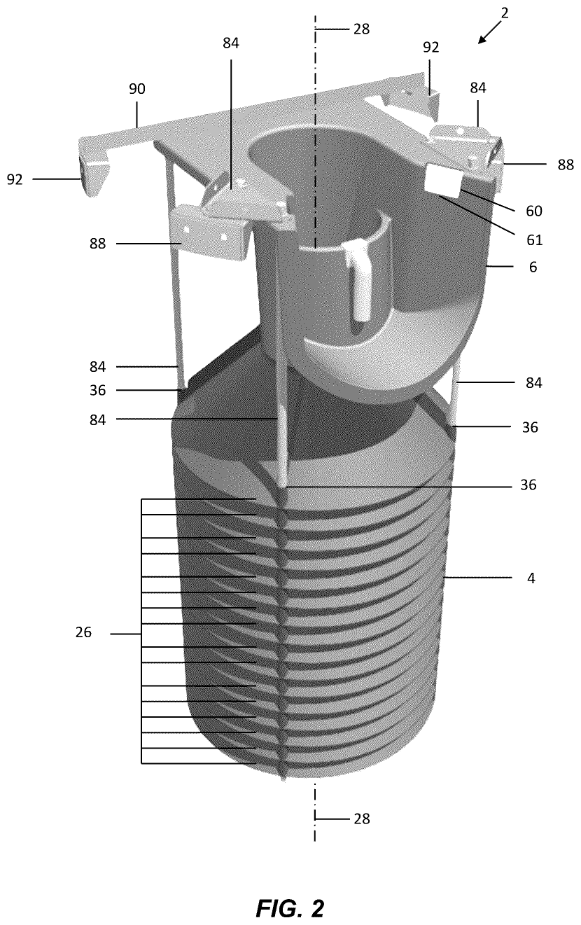

FIG. 2 is a perspective view of the lamella clarifier 4 and manifold 6 of the separator 2 in isolation. The lamella clarifier 4 comprises a plurality of conical settling plates 26 that extend along a vertical separator axis 28. The lamella clarifier 4 may alternatively be referred to as a cone stack. In alternative embodiments, the settling plates 26 may instead be planar. Sixteen settling plates 26 are shown in FIG. 2, although it will be appreciated that any number of a plurality of settling plates 26 may be used in alternative embodiments. Each of the plurality of settling plates 26 is connected to its neighbouring settling plate or plates 26. The manifold 6 is connected to an uppermost plate 26 of the plurality of plates 26.

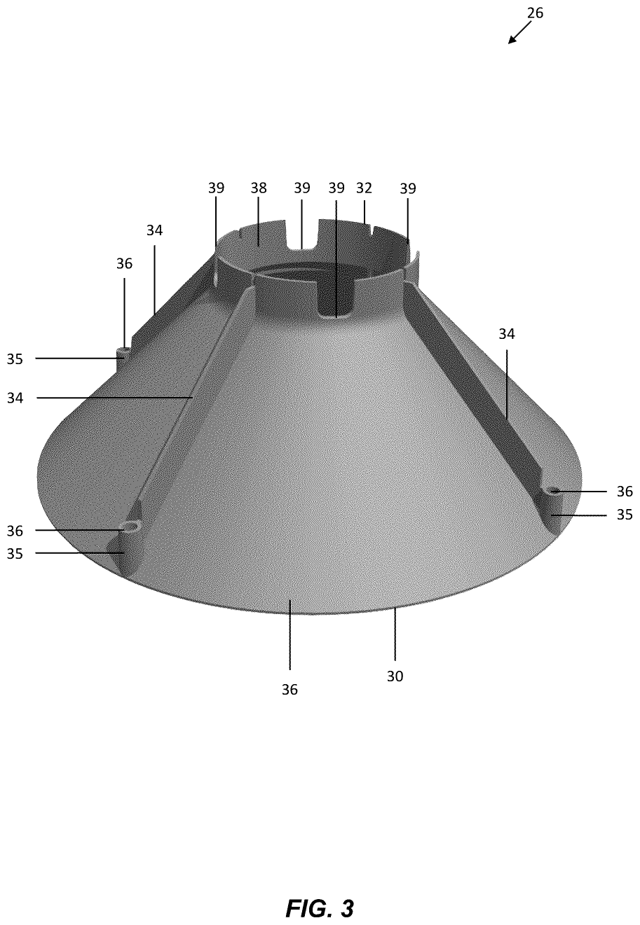

FIG. 3 is a perspective view of one of the settling plates 26 of the lamella clarifier 4 in isolation. Each of the settling plates 26 may be identical. As shown, the settling plate 26 (also referred to as a tray) has a generally frustoconical outer profile. The settling plate 26 extends between a lower circular rim 30 and an upper circular rim 32. The settling plate 26 comprises a plurality of ribs 34 that extend from an outer surface of the settling plate 26. The arrangement shown in FIG. 3 comprises four ribs 34 (three of which are shown), however it will be appreciated that more, fewer or no ribs 34 may be provided. The settling plate 26 further comprises a plurality of through holes 36. The through holes 36 are disposed proximal the lower circular rim 30. Each through hole 36 is defined by a respective boss 35 attached to a respective rib 34. The upper circular rim 32 is defined by an annular portion 38 of the settling plate 26, which extends away from the generally frustoconical outer profile of the remainder of the settling plate 26. The annular portion 38 comprises a plurality of recesses 39. Four recesses 39 are provided in the embodiment shown in FIG. 3, however it will be appreciated that more or fewer recesses 39 may be provided.

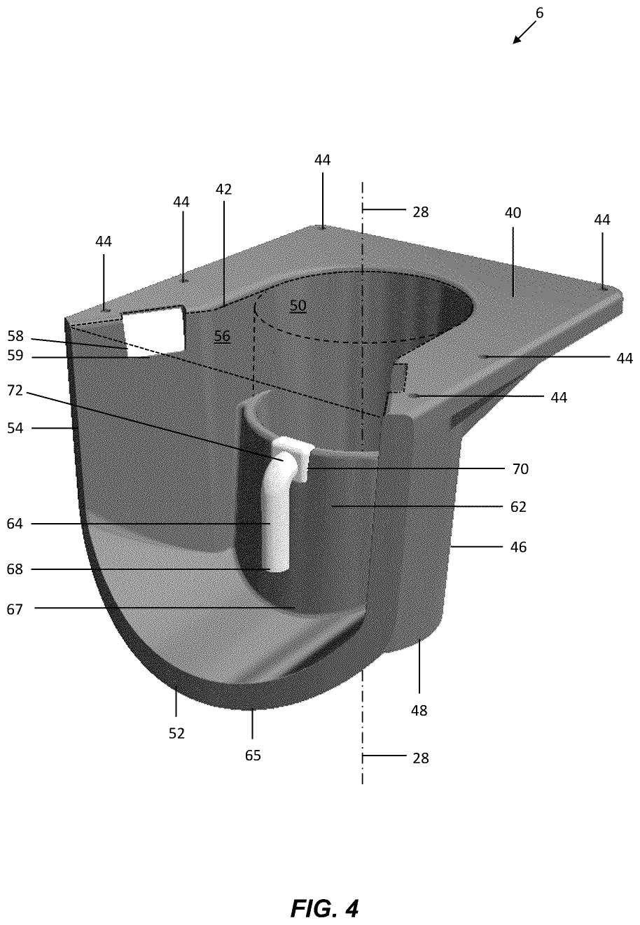

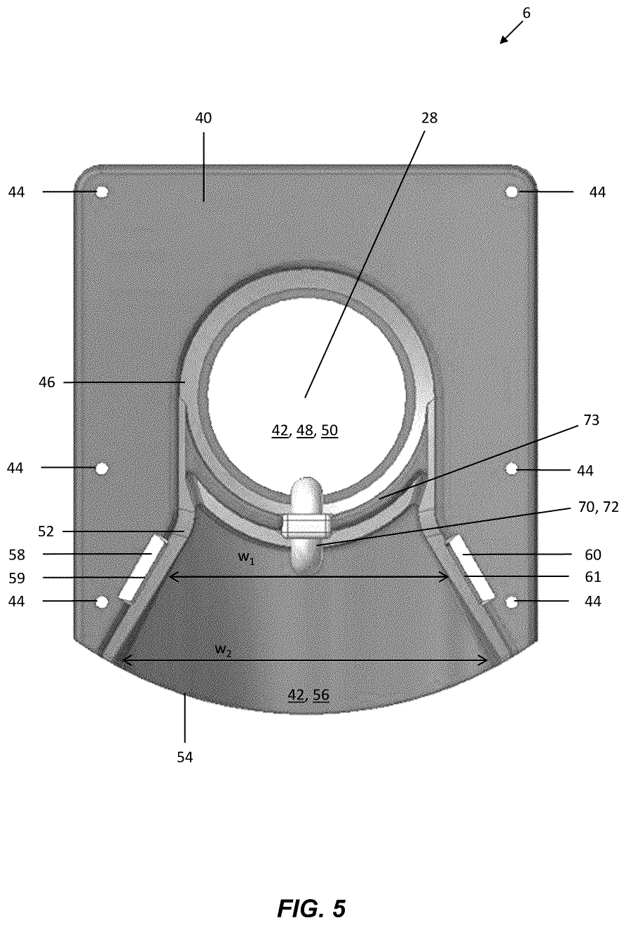

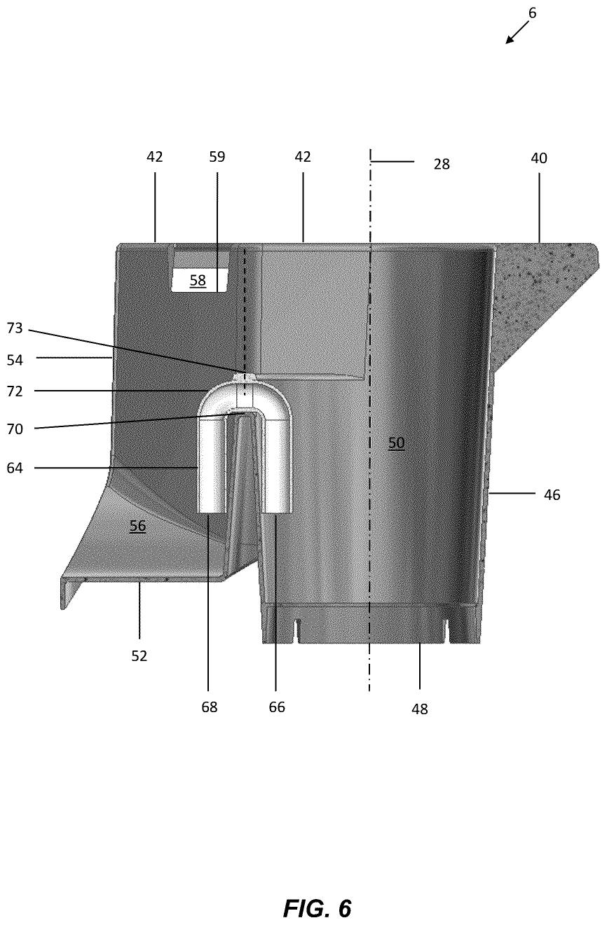

FIG. 4 is a perspective view showing the manifold 6 in isolation, FIG. 5 is a top view of the manifold 6 in isolation and FIG. 6 is a cross-sectional side view of the manifold 6 in isolation.

The manifold 6 has an interior (i.e. an inner space or chamber defined by the outer structure of the manifold 6). The manifold 6 is formed from a single layer of material (e.g. plastics material). The manifold 6 comprises a planar support member 40 that defines a bypass inlet 42 (also referred to as an emergency bypass). It will however be appreciated that in alternative embodiments the support member 40 may be omitted, with the bypass inlet 42 being defined by the remainder of the manifold 6. The bypass inlet 42 is disposed within the interior 14 of the vessel 8. The perimeter of the bypass inlet 42 is annotated in short-dashed lines in FIG. 4. The support member 40 further defines a plurality of openings 44.

A first portion 46 of the manifold 6 extends downwardly from the support member 40 to a manifold inlet 48. The first portion 46 of the manifold 6 defines a first portion 50 of the interior of the manifold 6 (hereinafter referred to as a first interior portion 50). As shown best in FIGS. 5 and 6, a portion of the first portion 46 of the manifold 6 is substantially cylindrical. The cylindrical profile of the first portion 46 of the manifold 6 is slightly tapered such that the profile of the first interior portion 50 tapers in a downward direction, towards the manifold inlet 48. The separator axis 28 extends through a centre of the manifold inlet 48. The cylindrical profile of the first portion 46 is centred on the separator axis 28.

A second portion 52 of the manifold 6 extends downwardly from the support member 40 and outwardly from the first portion 46 of the manifold 6 to a manifold outlet 54. The bypass inlet 42 and the manifold outlet 54 are contiguous, with their common boundary being represented by a short-dashed dashed line in FIG. 4. It will be appreciated that in alternative embodiments, the bypass inlet and manifold outlet may instead be separated, for example by a bridging portion of the manifold that extends between opposing sides of the manifold. The second portion 52 of the manifold 6 defines a second portion 56 of the interior of the manifold 6 (hereinafter referred to as a second interior portion 56). The first interior portion 50 and the second interior portion 56 are fluidically connected to each other.

As shown best in FIG. 5, the second portion 52 of the manifold 6 diverges away from the first interior portion 50 to the manifold outlet 54. That is, the second portion 52 of the manifold 6 diverges along a direction transverse to the separator axis 28 from the first interior portion 50 to the manifold outlet 54. Accordingly, a width w₁ of the second portion 52 at a position proximal to the first interior portion 50 is less than a width w₂ of the second portion 52 at a position distal to the first interior portion 50.

In addition to defining the bypass inlet 42, the manifold 6 also defines a first further bypass inlet 58 and a second further bypass inlet 60. The first and second further bypass inlets 58, 60 are defined by the second portion 52 of the manifold 6 and open into the second interior portion 56. The first and second further bypass inlets 58, 60 are disposed within the interior 14 of the vessel 8. The first and second bypass inlets 58, 60 are defined by opposing walls of the second portion 52 of the manifold 6 that diverge in the manner described above. Accordingly, the first and second bypass inlets 58, 60 are angled away from the first interior portion 50 and toward the manifold outlet 54. The area of the bypass inlet 42 is greater than the combined area of the first and second further bypass inlets 58, 60.

The manifold 6 further comprises a weir 62 that partially separates the first interior portion 50 and the second interior portion 56. A first side of the weir 62 is defined by the first portion 46 of the manifold 6 and a second side of the weir 62 is defined by the second portion 52. The portion of the first and second portions 46, 52 of the manifold 6 that define the weir 62 are substantially cylindrical, such that the weir 62 is arched or semicircular. The weir 62 is convex in the direction of the manifold outlet 54. It will however be appreciated that the weir 62 may have a different form, such as a linear form. As shown best in FIG. 6, the cylindrical profiles of the first and second portions 46, 52 of the manifold 6 that define the weir 62 are slightly tapered such that the profile of the weir 62 tapers in an upward direction, away from the manifold inlet 48. A portion 65 of the second portion 52 that extends between a base 67 of the weir 62 and the manifold outlet 54 is concave (i.e. concave in a direction toward the manifold inlet 48).

The manifold 6 further comprises a siphon 64 having an inlet 66 disposed in the first interior portion 50 and an outlet 68 disposed in the second interior portion 56. The weir 62 comprises a notch 70 through which the siphon 64 extends. A crest portion 72 of the siphon 64 is supported by and extends across the entirety of the notch 70. An upper edge of the crest portion 72 is substantially linear and is substantially aligned with a lip 73 (i.e. crest) of the weir 62.

As shown most clearly in FIG. 6, an upward leg of the siphon 64 extending from the inlet 66 to the crest portion 72 is equal in length to a downward leg of the siphon 64 extending from the crest portion 72 to the outlet 68. Accordingly, the inlet 66 and the outlet 68 are disposed at the same level. The level of the inlet 66 to the siphon 64 and the level of the outlet 68 to the siphon 64 are between the level of the lip 73 of the weir 62 and the level of the manifold inlet 48. The first and second further bypass inlets 58, 60 are disposed between the lip 73 of the weir 62 and the bypass inlet 42. In particular, the first and second further bypass inlets 58, 60 comprise respective lower lips 59, 61 disposed at a level that is between the level of the lip 73 of the weir 62 and the level of the bypass inlet 42.

Returning to FIG. 2, the separator 2 comprises a plurality of support rods 84 that extend through the plurality of through holes 36, 44. The upper ends of the plurality of support rods 84 located proximal the manifold outlet 54 are connected to a first end of respective horizontal brackets 86, which are in turn connected to vertical brackets 88. The upper ends of the plurality of support rods 84 located distal the manifold outlet 54 are connected to a further horizontal bracket 90. First and second further vertical brackets 92 are connected to ends of the further horizontal bracket 90.

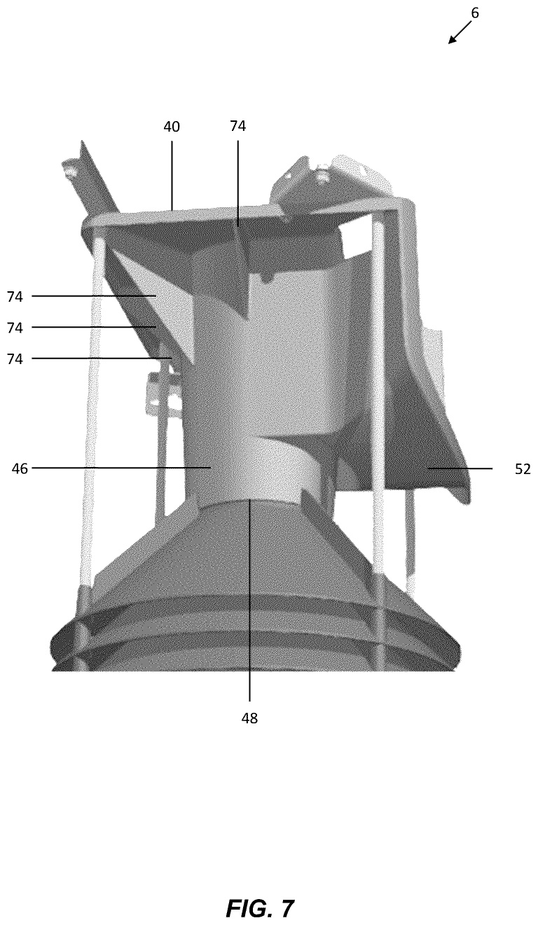

FIG. 7 is a perspective view of an underside of the manifold 6. As shown, a plurality of ribs 74 extend between the support member 40 and the first portion 46 of the manifold 6. The ribs 74 increase the rigidity of the manifold 6.

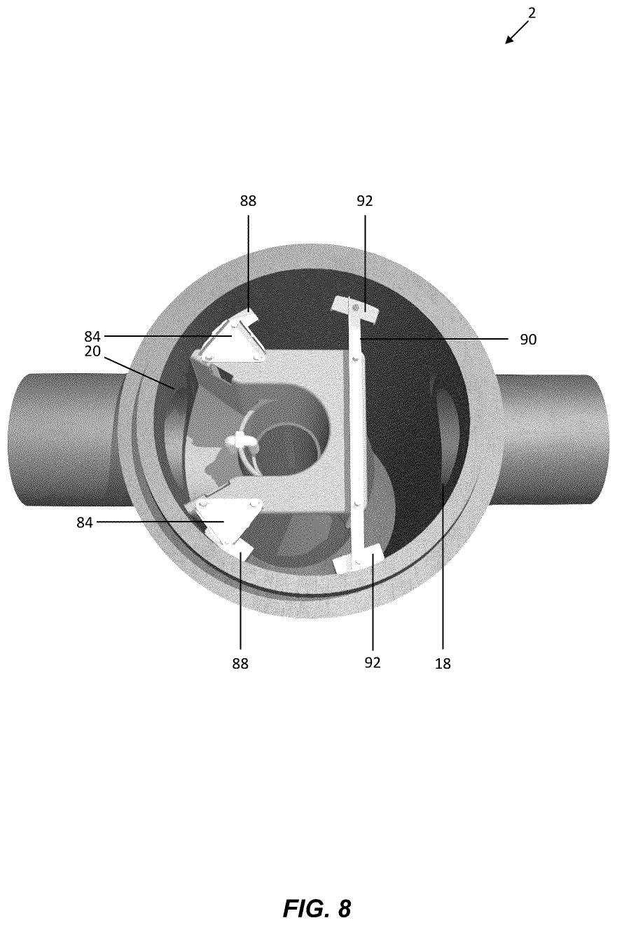

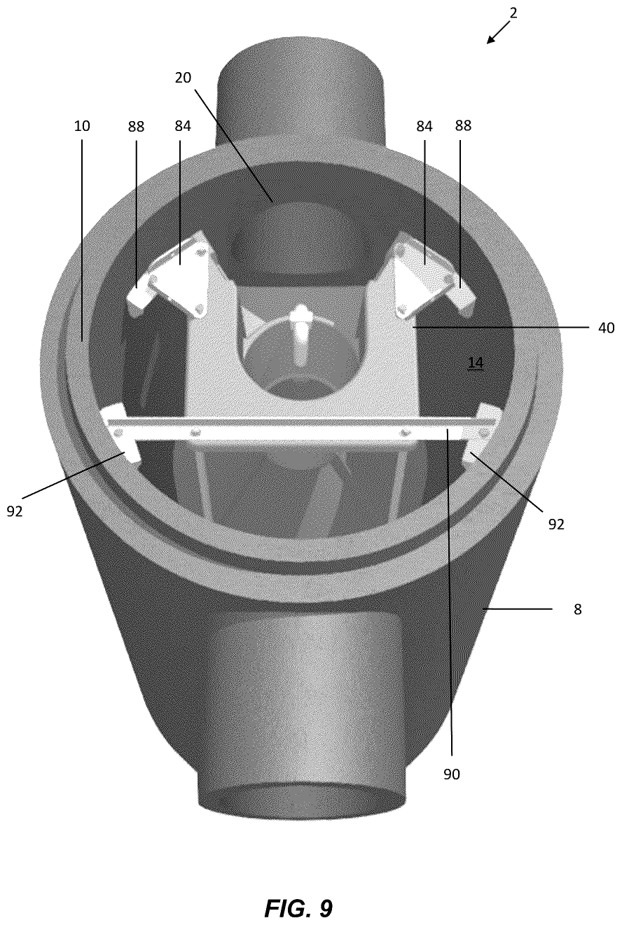

FIG. 8 and FIG. 9 are further perspective views of the separator 2. As shown, the manifold 6 is positioned within the interior 14 of the vessel 8 such that the manifold outlet 54 of the manifold 6 is aligned with the outlet 20 of the vessel 8. The vertical brackets 88 and further vertical brackets 92 are attached to the side wall 10 of the vessel 8 to secure the manifold 6 and lamella clarifier 4 within the interior 14 of the vessel 8.

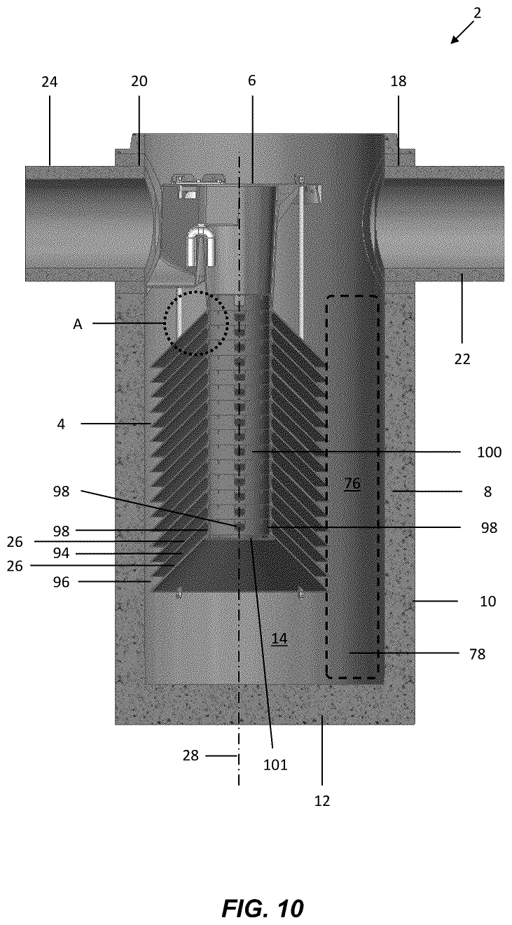

FIG. 10 is a cross-sectional side view of the separator 2. As shown, the lowermost edge of the inlet 18 of the vessel 8 and the lowermost edge of the outlet 20 of the vessel 8 are positioned at the same height. The inlet 66 and outlet 68 of the siphon 64 are disposed at a higher level than the lowermost edges of the inlet and outlet 18, 20 of the vessel 8.

The separator axis 28 of the lamella clarifier 4 is offset from the centre of the vessel 8 in a direction of the outlet 20 of the vessel 8. This provides a settling forebay 76 within the interior 14 of the vessel 8 the perimeter of which is approximated in dashed lines in FIG. 10. The flow velocities within the interior 14 of the vessel 8 are lowest away from the lamella clarifier 4. Accordingly, the settling forebay 76 promotes the settlement of solids material within the interior 14 of the vessel 8 and reduces the solids loading on the settling plates 26, which in turn reduces maintenance of the settling plates 26 and improves overall performance of the separator 2. The settling forebay 76 also provides a quiescent sump 78 for holding collected solids in between maintenance events. Vertical access to the quiescent sump 78 for removing solids is provided by the settling forebay 76.

The plurality of settling plates 26 define a plurality of channels 94 therebetween. Each of the plurality of channels 94 comprises a respective inlet 96 and a plurality of respective outlets 98. The plurality of inlets 96 are disposed at a radially outer portion of the lamella clarifier 4 and the plurality of outlets 98 are disposed at a radially inner portion of the lamella clarifier 4. A single channel 94 is annotated in FIG. 10 for clarity, however it will be appreciated that channels 94 and associated inlets 96 and outlets 98 are formed between each adjacent pair of settling plates 26.

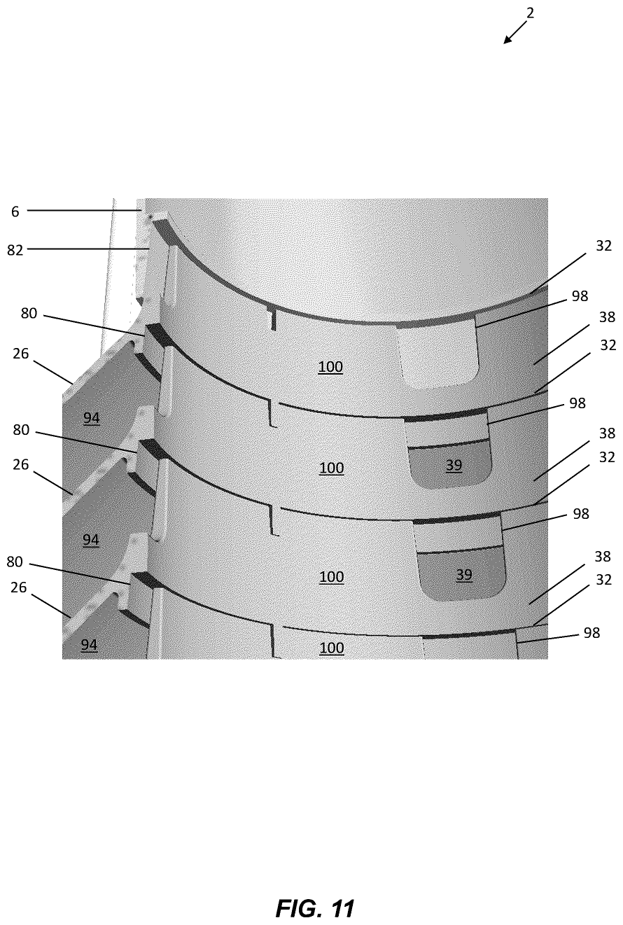

FIG. 11 is a close-up cross-sectional perspective view of an interface between the settling plates 26 and the manifold 6 taken at the position indicated by reference A in FIG. 10. As described above with reference to FIG. 3, each settling plate 26 comprises an upper circular rim 32 that is defined by an annular portion 38 of the settling plate 26. An inner surface of the annular portion 38 of each settling plate 26 is provided with an annular recess 80. Likewise, an inner surface of the manifold 6 adjacent manifold inlet 48 is provided an annular recess 82. The annular portion 38 of the uppermost of the plurality of settling plates 26 snap fits into the annular recess 82 of the manifold 6. The annular portions 38 the remaining settling plates 26 snap fit into the annular recess 80 of their adjacent overlying settling plate 26. The outlets 98 are defined by the recesses 39 of each of the settling plates 26 and their respective overlying settling plate 26. The annular portions 38 of the settling plates together define a central passageway 100 fluidically connected to the plurality of channels 94 via the outlets 98 and fluidically connected to the first interior portion 50 via the manifold inlet 48.

Although it has been described that the lamella clarifier 4 comprises a plurality of distinct settling plates that are connected to each other, in alternative embodiments the plurality of settling plates may form part of a single unitary structure. In addition, although it has been described that the lamella clarifier 4 and the manifold 6 are distinct parts that are connected to each other, in alternative embodiments they may instead form part of a single unitary structure.

Returning to FIG. 10, as shown, a cap 101 is attached to the lowermost plate 26 of the plurality of settling plates 26. An outer rim of the cap 101 snap fits into the annular recess 80 of the lowermost settling plate 26. The cap 101 extends across the entirety of the annular portion 38 of the lowermost settling plate 26 such that it seals the central passageway 100 from direct fluid communication with the interior 14 of the vessel 8.

During operation, a fluid containing solids enters the interior 14 of the vessel 8 via the inlet 18 of the vessel 8. The fluid enters the channels 94 via the inlets 96 and passes in an upward direction along the channels 94 towards the outlets 98. Solids that are suspended in the fluid settle on the settling plates 26, slide down the settling plates 26 and exit the channels 94 via the inlets 96. Solids exiting the channels 94 via the inlets 96 settles on the base 12 of the vessel 8 (e.g. within the quiescent sump 78) for later collection. The fluid in the channels 94 enters the central passageway 100 via the outlets 98, passes upwards along the central passageway 100 and enters the first interior portion 50 via the manifold inlet 48. Due to the presence of the cap 101, fluid in the interior 14 of the vessel 8 that does not enter the central passageway 100 via the bypass inlets 42, 58, 60 must enter the central passageway 100 via the channels 94.

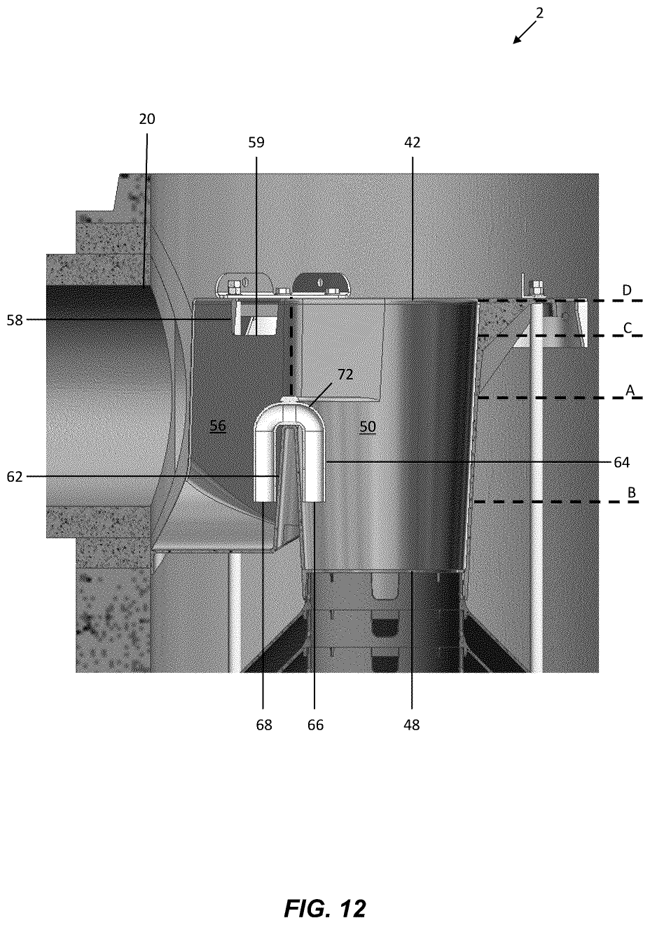

FIG. 12 is a close-up cross-sectional view of the separator 2 at a region of the manifold 6 and outlet 20 of the vessel 8.

During relatively low flow conditions, fluid that enters the first interior portion 50 via the manifold inlet 48 rises within the manifold 6 to level A and passes over the lip 73 of the weir 62, into the second interior portion 56, and exits the separator 2 to an exterior of the vessel 8 via the outlet 20. Simultaneously, fluid enters the siphon 64 via the inlet 66, passes through the crest portion 72 and exits the outlet 68 to initiate the siphon 64. The siphon effect draws the fluid from the first interior portion 50 into the second interior portion 56 via the siphon 64.

If the rate of flow into the vessel 8 via the inlet 18 reduces, the level of the fluid in the first interior portion 50 correspondingly reduces. Firstly, the level of fluid in the first interior portion 50 reduces to below the level of the lip 73 of the weir 62 (i.e. level A) such that fluid no longer passes over the lip 73 of the weir 62 from the first interior portion 50 to the second interior portion 56. Since the level of fluid in the first interior portion 50 continues to be greater than the level of fluid within the second interior portion 56, the siphon effect continues to draw the fluid from the first interior portion 50 into the second interior portion 56 via the siphon 64. Once the level of fluid in the first interior portion 50 reduces to the level of the inlet 66 to the siphon 64 (i.e. level B), the siphon effect is broken. Breaking of the siphon effect results in backwashing of the siphon 64, which minimises clogging of the siphon 64. Since the inlet 66 to the siphon 64 is positioned within the first interior portion 50 (e.g. rather than in the remainder of the interior 14 of the vessel 8), only treated fluid is released when the separator 2 drains down after a storm. The inlet conduit 22 is angled in a downward direction toward the inlet 18 of the vessel 8 and the level of the inlet 66 and outlet 68 to the siphon 64 is slightly higher than the lowermost edges of the inlet and outlet 18, 20 of the vessel 8. Accordingly, fluid does not collect in the inlet conduit 22 after a storm event and is drained down.

During such relatively low flow conditions, the rate at which fluid passes through the lamella clarifier 4 is sufficiently high compared to the rate of flow into the vessel 8 that the fluid does not reach the level of the lower lips 59, 61 (i.e. crests) of the first and second further bypass inlets 58, 60 (i.e. level C). Accordingly, all fluid that enters the manifold 6 enters from the lamella clarifier 4, and, thus, has been processed by the lamella clarifier 4.

Providing a weir 62 increases the fluid level in the first interior portion 50, the interior 14 of the vessel 8 and the inlet conduit 22. Accordingly, the cross-sectional area of fluid within the inlet conduit 22 on a plane transverse to the inlet conduit 22 is increased. Since providing a weir 62 does not result in a change in the flow rate of fluid passing through the inlet conduit 22, the flow velocity of fluid passing through the inlet conduit 22 decreases. This in turn reduces the velocity of fluid within the interior 14 of the vessel 8, which improves settling efficiency. It will however be appreciated that in alternative embodiments the weir 62 need not be provided.

During higher flow conditions, the rate of flow into the vessel 8 exceeds the rate at which fluid is able to be processed by the lamella clarifier 4. In such circumstances, fluid in the vessel 8 reaches a higher level than the level of the lower lips 59, 61 of the first and second further bypass inlets 58, 60 (i.e. level C). Accordingly, the manifold 6 receives a first portion of fluid via the lamella clarifier 4 and receives a second portion of fluid via the first and second further bypass inlets 58, 60, and, thus, the fluid exiting the separator 2 to the exterior of the vessel 8 via the outlet 20 is a mixture of processed and unprocessed fluid.

The first and second further bypass inlets 58, 60 allow untreated fluid (i.e. the second portion of fluid) to bypass the lamella clarifier 4 during higher flow conditions. The first and second bypass inlets 58, 60 angled away from the first interior portion 50 and the weir 62 is able to convey a large volume of fluid. Accordingly, none of the untreated fluid entering the manifold 6 via the first and second further bypass inlets 58, 60 is directed downward into the lamella clarifier 4. During higher flow conditions, the lips 59, 61 of the first and second further bypass inlets 58, 60 become submerged and the fluid levels inside and outside the manifold 6 equalize. Since the flow rate through the lamella clarifier 4 is positively correlated with the pressure differential between the fluid levels inside and outside the manifold 6, allowing the fluid to pass through the first and second further bypass inlets 58, 60 avoids an increase in the flow rate through the lamella clarifier 4 and the interior 14 of the vessel 8 and a corresponding reduction in the resuspension of material captured in the sump 78.

In such circumstances, the siphon 64 is initiated and acts to lower the level of the fluid in the first interior portion 50. This increases the rate at which the fluid passes through the lamella clarifier 4, which can in turn reduce the time taken for the level of fluid in the vessel 8 to reduce below the lips 59, 61 of the of the first and second further bypass inlets 58, 60 (i.e. level C), and, thus, reduce the time taken for the separator 2 to return to solely outputting processed fluid via the outlet 20 of the vessel 8.

During highest flow conditions, fluid in the vessel 8 reaches a higher level than the level of the bypass inlet 42 (i.e. level D). Since the bypass inlet 42 is disposed within the interior 14 of the vessel 8, the manifold 6 receives a first portion of fluid via the lamella clarifier 4 and not via the bypass inlet 42 or first and second bypass inlets 58, 60, receives a second portion of fluid via the bypass inlet 42 and not via the lamella clarifier 4 or first and second bypass inlets 58, 60 and receives a third portion of fluid via the first and second further bypass inlets 58, 60 and not via the lamella clarifier 4 or bypass inlet 42. Accordingly, the fluid exiting the separator 2 to the exterior of the vessel 8 via the outlet 20 is a mixture of processed and unprocessed fluid.

As mentioned above, the area of the bypass inlet 42 is greater than the combined area of the first and second further bypass inlets 58, 60. Accordingly, under the highest flow conditions the rate of flow through the bypass inlet 42 is greater than the rate of flow through the first and second further bypass inlets 58, 60, which can in turn reduce the time taken for the level of fluid in the vessel 8 to reduce below the lips 59, 61 of the first and second further bypass inlets 58, 60 (i.e. level C), and, thus, reduce the time taken for the separator 2 to return to solely outputting processed fluid via the outlet 20 of the vessel 8.

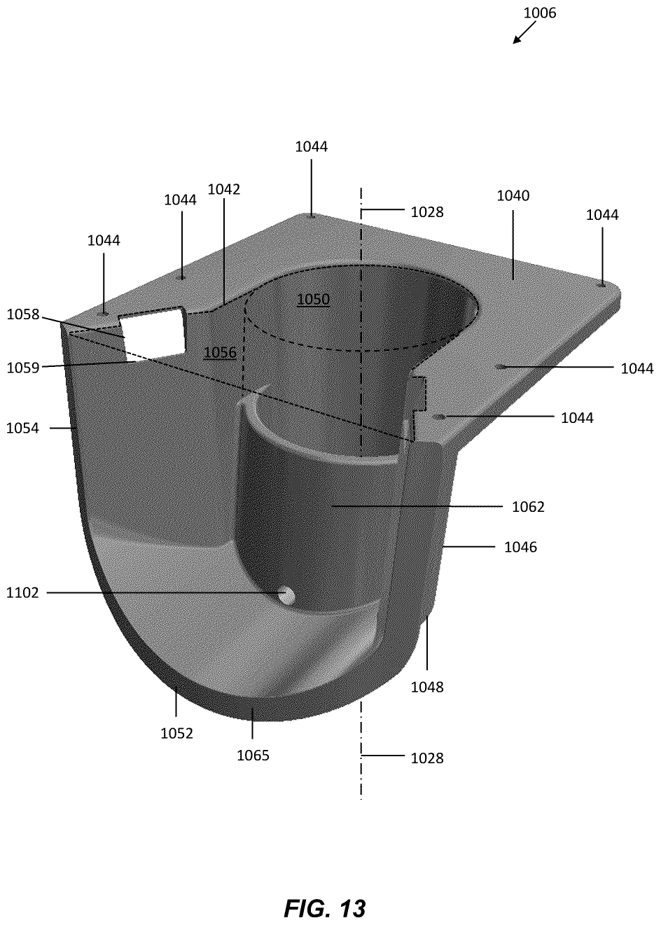

FIG. 13 is a perspective view showing a first alternative manifold 1006, which may be used instead of the manifold 6 described with reference to FIGS. 1 to 12. The first alternative manifold 1006 substantially corresponds to the manifold 6 in terms of its structure and function except in the respects described below, and features of the first alternative manifold 1006 that correspond to the features of the manifold 6 are denoted with corresponding reference numerals with the addition of a value of 1000.

The first alternative manifold 1006 differs from the manifold 6 in that the first alternative manifold 1006 does not comprise a siphon 64, and the weir 1062 of the first alternative manifold 1006 does not comprise a notch 70. Instead, the weir 1062 of the first alternative manifold 1006 comprises a drainage opening 1102 that extends between the first interior portion 1050 and the second interior portion 1056. Providing a drainage opening 1102 rather than a siphon may result in a simpler and less expensive manufacturing process. The drainage opening 1102 is disposed at a lower portion of the weir 1062, below the lowermost edges of the inlet and outlet 18, 20 of the vessel 8.

The first alternative manifold 1006 functions in a similar manner to the manifold 6 described with reference to FIGS. 1 to 12. However, a portion of the fluid within the first interior portion 1050 passes to the second interior portion 1056 via the drainage opening 1102 rather than through a siphon. During typical flow conditions (e.g. during storm events), not all flow entering the first interior portion 1050 via from the lamella clarifier 4 is able to pass through the drainage opening 1102, and, thus, the weir 1062 provides the same advantages referred to above with reference to the manifold 6. That is, the weir 1062 still increases the fluid level in the inlet conduit 22 such that that the flow velocity of fluid passing through the inlet conduit 22 and entering the interior 14 of the vessel 8 is reduced.

If the rate of flow into the vessel 8 via the inlet 18 reduces, the level of the fluid in the first interior portion 50 correspondingly lowers. Firstly, the level of fluid in the first interior portion 50 reduces to below the level of the lip 73 of the weir 62 such that fluid no longer passes over the lip 73 of the weir 62 from the first interior portion 50 to the second interior portion 56. Fluid continues to flow though the drainage opening 1102 from the first interior portion 1050 to the second interior portion 1056. Since the drainage opening 1102 is disposed below the lowermost edges of the inlet and outlet 18, 20 of the vessel 8, the fluid in inlet conduit 22 is drained down after a storm event.

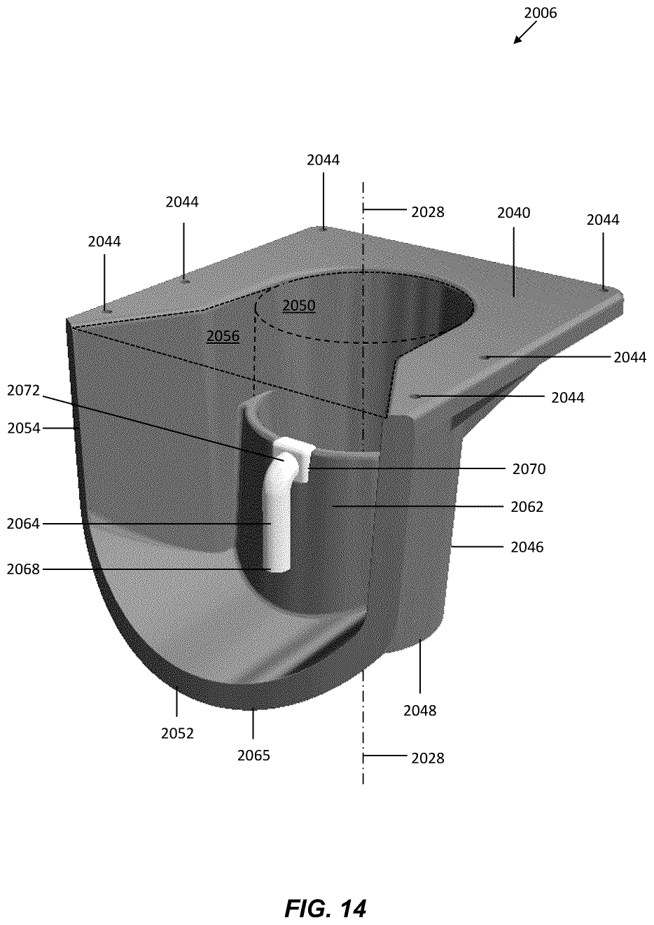

FIG. 14 is a perspective view showing a second alternative manifold 2006, which may be used instead of the manifold 6 described with reference to FIGS. 1 to 12. The second alternative manifold 2006 substantially corresponds to the manifold 6 in terms of its structure and function except in the respects described below, and features of the second alternative manifold 2006 that correspond to the features of the manifold 6 are denoted with corresponding reference numerals with the addition of a value of 2000.

The second alternative manifold 2006 differs from the manifold 6 in that the second alternative manifold 2006 does not comprise a first further bypass inlet 58 and a second further bypass inlet 60. The second alternative manifold 2006 functions in a similar manner to the manifold 6 described with reference to FIGS. 1 to 12. However, during the higher flow conditions scenario referred to above, the second portion of fluid is retained with the vessel 8 and does not pass through a first further bypass inlet 58 or a second further bypass inlet 60. Instead, when fluid in the vessel 8 reaches a level higher than the level of the bypass inlet 1042, the manifold 1006 receives a first portion of fluid via the lamella clarifier 1004 and receives a second portion of fluid via the bypass inlet 1042. Not providing the first and second further bypass inlets 58, 60 simplifies the manufacturing process. However, compared to the second alternative manifold 2006, providing both the first and second further bypass inlets 58, 60 and the bypass inlet 42 (i.e. as in the manifold 6 and first alternative manifold 1006) allows for more precise control over the point at which the respective manifolds begin to bypass. For example, the height of the first and second further bypass inlets 58, 60 of the manifold 6 could be increased or decreased to increase or decrease the flow rate into the separator 2 at which bypass occurs depending on the number of settling plates 26 in the lamella clarifier 4 or depending on local stormwater regulations.

It will be appreciated that, as with second alternative manifold 2006, the first alternative manifold 1006 may not comprise a first further bypass inlet 58 and a second further bypass inlet 60. It will further be appreciated that, in embodiments having a further bypass inlet, a single further bypass may be provided or more than two further bypasses may be provided.

Although it has been described that a single lamella clarifier and manifold are disposed in the interior of the vessel, it will be appreciated that multiple lamella clarifiers and associated manifolds may be disposed in the interior of the vessel. In such embodiments, the vessel may comprise a plurality of outlets and each of the plurality of manifolds may be connected to a respective one of the plurality of outlets.

1. A separator for separating solids from a fluid, the separator comprising a vessel, a lamella clarifier and manifold, the vessel comprising an inlet and an outlet, the lamella clarifier and the manifold being disposed in an interior of the vessel, the interior of the vessel being configured to receive the fluid via the inlet of the vessel, the manifold having an interior and comprising a manifold inlet, a manifold outlet and a bypass inlet,
wherein the manifold inlet is fluidically connected to the lamella clarifier such that the interior of the manifold is configured to receive a first portion of the fluid from the lamella clarifier via the manifold inlet,
wherein the bypass inlet is disposed within the interior of the vessel such that the interior of the manifold is configured to receive a second portion of the fluid from the interior of the vessel via the bypass inlet and not via the lamella clarifier,
wherein the manifold outlet is fluidically connected to the outlet of the vessel such that it is configured to discharge the first and second portions of fluid received in the interior of the manifold to an exterior of the vessel.

2. The separator as claimed in claim 1, wherein the interior of the manifold comprises a first interior portion that is configured to receive the first portion of the fluid from the lamella clarifier via the manifold inlet and a second interior portion from which the manifold outlet is configured to discharge the first and second portions of fluid to the exterior of the vessel, wherein the manifold further comprises a weir partially separating the first interior portion and the second interior portion.

3. The separator as claimed in claim 2, wherein the weir is arched.

4. The separator as claimed in claim 2, wherein the separator further comprises a siphon having an inlet disposed in the first interior portion and an outlet disposed in the second interior portion, wherein the level of the inlet to the siphon and the level of the outlet to the siphon are between the level of a lip of the weir and the level of the manifold inlet such that the siphon is configured to at least partially drain down fluid from the first interior portion to the second interior portion.

5. The separator as claimed in claim 4, wherein the weir comprises a notch configured to receive a crest portion of the siphon.

6. The separator as claimed in claim 2, wherein the weir comprises a drainage opening extending between the first interior portion and the second interior portion.

7. The separator as claimed in claim 2, wherein at least a portion of the manifold that extends between the manifold inlet and the bypass inlet and that defines the first interior portion is substantially cylindrical.

8. The separator as claimed in claim 2, wherein at least a portion of the manifold that extends between the first interior portion and the manifold outlet and that defines the second interior portion diverges away from the first interior portion to the manifold outlet.

9. The separator as claimed in claim 2, wherein at least a portion of the manifold that extends between a base of the weir and the manifold outlet is concave.

10. The separator as claimed in claim 2, wherein the manifold comprises one or more further bypass inlets, wherein the one or more further bypass inlets are disposed within the interior of the vessel such that the interior of the manifold is configured to receive a third portion of the fluid from the interior of the vessel via the one or more further bypass inlets and not via the lamella clarifier and not via the bypass inlet, wherein each of the one or more further bypass inlets comprises a lip over which the third portion of fluid is configured to flow, wherein the level of each of the lips of the one or more further bypass inlets is between the level of a lip of the weir and the level of the bypass inlet.

11. (canceled)

12. The separator as claimed in claim 2, wherein the manifold comprises a substantially planar support member that defines the bypass inlet, wherein a portion of the manifold that defines the first interior portion and a portion of the manifold that defines the second interior portion extend from the support member.

13. The separator as claimed in claim 12, wherein the lamella clarifier comprises a plurality of frustoconical settling plates spaced apart along a separator axis, wherein the separator further comprises a plurality of support rods extending through each of the plurality of settling plates and connecting to the support member of the manifold.

14. The separator as claimed in claim 1, wherein the bypass inlet and the manifold outlet are contiguous.

15. (canceled)

16. The separator as claimed in claim 9, wherein the manifold comprises one or more further bypass inlets, wherein the one or more further bypass inlets are disposed within the interior of the vessel such that the interior of the manifold is configured to receive a third portion of the fluid from the interior of the vessel via the one or more further bypass inlets and not via the lamella clarifier and not via the bypass inlet, wherein each of the one or more further bypass inlets comprises a lip over which the third portion of fluid is configured to flow, wherein the level of each of the lips of the one or more further bypass inlets is between the level of a lip of the weir and the level of the bypass inlet.

17. A separator as claimed in claim 16, wherein the one or more further bypass inlets are defined by at least one of the portions of the manifold that diverge away from the first interior portion to the manifold outlet.
